(19) United States
(12) Patent Application Publication
(10) Pub. No.: US 2006/0053316 A1
(43) Pub. Date: Mar. 9, 2006

(54) Information processing apparatus, control method, and program product

(75) Inventors: Mitsuhiro Yamazaki, Kanagawa-Ken (JP); Shinji Matsushima, Yokohama-Shi (JP); Yasumichi Tsukamoto, Yamato-Shi (JP)

Correspondence Address: LENOVO (US) IP Law, Mail Stop ZHHA/B675/PO Box 12195, 3039 Cornwallis Road, RTP, NC, 27709-2195, US

(73) Assignee: LENOVO (SINGAPORE) Pte. Ltd., Singapore (SG)

(21) Appl. No.: 11/195,061

(22) Filed: Aug. 2, 2005

(30) Foreign Application Priority Data
Jul. 30, 2004 (JP) JP2004-224685

(51) Int. Cl. G06F 1/26

(52) U.S. Cl. 713/300

(57) ABSTRACT

An information processing apparatus is provided, which includes: plural devices, each having a high-power mode as an operation mode in which power consumption and processing speed are high, and a low-power mode as an operation mode in which power consumption and processing speed are lower than the power consumption and processing speed of the high-power mode; a measurement unit which measures temperature of a predetermined measurement point; a device selection unit which selects a device to be minimized degradation in processing performance when an operation mode is changed from the high-power mode to the low-power mode to lower the temperature of the measurement point in a case that the measured temperature is equal to or higher than a predetermined reference temperature; and an operation mode setting unit which changes the operation mode of the selected device from the higher-power mode to the lower-power mode.

### BACKGROUND OF THE INVENTION

The present invention relates to an information processing apparatus, a control method, a program, and a recording medium. In particular, the present invention relates to an information processing apparatus which controls heat generation thereof, relates to a control method and a program, which are for controlling the heat generation, and relates to a recording medium recording the program.

In recent years, as devices for use in an information processing apparatus have had higher performance and have been miniaturized more, it has been more important to take measures against heat generation of the devices. In particular, in the recent information processing apparatus, not only a CPU but also a graphics controller, a control chip, a memory and the like have generated more heat. Therefore, it has been more and more important to take measures against the heat generation of the information processing apparatus as a whole.

As an example of the measures against the heat generation, it is conceived to assume a case where all of the devices operate at the maximum allowable power, and to provide a heat exhausting mechanism in the information processing apparatus such that the information processing apparatus operates normally even in the case assumed as described above. However, it is rare that all of the devices operate at the maximum allowable power, and accordingly, while a scale and cost of the heat exhausting mechanism are increased, and the information processing apparatus is enlarged, an advantage to a user, which is brought about by providing the exhausting mechanism described above, is only a little.

Meanwhile, things which have been heretofore performed are to provide a heat exhausting mechanism capable of appropriate heat exhaustion and to provide temperature measuring functions to some of the devices such as the CPU. In this case, when a measured temperature exceeds a certain reference temperature, voltage of the CPU is lowered. In such a way, the device which is known in advance to generate the heat can be protected from overheating. As described above, a technology for controlling a supply of a power source to some of the devices of the information processing apparatus has been heretofore used for various applications.

For example, a technology has been proposed, which, when temperature of a certain portion reaches such a reference temperature or higher, sequentially switches the devices to a power saving mode in a predetermined order until the temperature concerned falls to lower than the reference temperature (refer to Japanese Patent Laid-Open No. Hei 5 (1993)-127785 (Patent Document 1)). Moreover, a technology has been proposed, which determines to which power saving mode an operation mode of the device is to be switched based on a type of an event which has occurred and a parameter of the device concerned (refer to Japanese Patent Laid-Open No. Hei 8 (1996)-87359 (Patent Document 2)). For example, this technology determines to which power saving mode the operation mode of the device is to be switched based on a throughput of the device, a battery remaining amount, and the like (refer to FIG. 10 in Patent Document 2).

Furthermore, such technologies are effective not only for preventing the overheating but also for power saving. For example, a technology has been used, which controls the number of CPUs to be operated depending on whether the information processing apparatus is operating by a battery or by an AC power source (refer to Japanese Patent Laid-Open No. Hei 9 (1997)-138716 (Patent Document 3)).

Patent Document 1 discloses that the order of the devices switched to the power saving mode is predetermined. And, Patent Document 2 discloses that the power saving mode to which the operation mode is to be switched is uniquely determined depending on the type of the event which has occurred and the parameter of the device. However, an appropriate device of which operation mode is to be switched and/or an appropriate operation mode of the device of which operation mode is to be switched depends on processing performed by the information processing apparatus. Therefore, according to these technologies, the processing speed may be lowered more than necessary and the temperature may not be lowered sufficiently.

### SUMMARY OF THE INVENTION

In this connection, it is a purpose of the present invention to provide an information processing apparatus, a control method, a program, and a recording medium, which are capable of solving the above-described problems. This purpose is attained by a combination of features described in independent claims in the scope of claims. Moreover, dependent claims define more advantageous specific examples of the present invention.

In order to solve the above-described problems, in a fist aspect of the present invention, an information processing apparatus is provided, which comprises: at least two devices, each having at least two operation modes corresponding to power consumption and/or processing speed thereof; a measurement unit which measures temperature of a predetermined measurement point to be measured in the apparatus; a device selection unit which selects a device to be minimized the degradation in processing performance in a case that an operation mode is changed from first operation mode to second operation mode in which the power consumption and/or the processing speed are lower than those in the first operation mode to lower the temperature of the predetermined measurement point if the measured temperature is equal to or higher than a predetermined reference temperature; and an operation mode setting unit which changes the operation mode of the selected device from the first operation mode to the second operation mode. Moreover, provided are: a control method for controlling the information processing apparatus; a program for controlling the information processing apparatus; and a recording medium recording the program.

Note that the above-described summary of the invention does not list all features necessary for the present invention, and subcombinations of groups of these features can also be incorporated in the invention.

### BRIEF DESCRIPTION OF THE DRAWINGS

For a more complete understanding of the present invention and the advantages thereof, reference is now made to the following description taken in conjunction with the accompanying drawings.

FIG. 1 shows a configuration of an information processing apparatus 10.

FIG. 2 shows an example of heat conduction in the information processing apparatus 10.

FIG. 3 shows examples of information about performance/temperature 1045-1 and information about performance/temperature 1045-2.

FIG. 4 shows examples of information about performance/temperature 1045-3 and information about performance/temperature 1045-4.

FIG. 5 shows an example of a functional block diagram of a central processing unit 1000.

FIG. 6 shows an example of processing for changing an operation mode of a device from a high-power mode to a low-power mode.

FIG. 7 shows details of processing in S550 of FIG. 6.

FIG. 8 shows an example of processing for changing the operation mode of the device from the low-power mode to the high-power mode.

FIG. 9 shows temperature changes caused by changing the operation modes of the plural devices.

### DETAILED DESCRIPTION OF THE PREFERRED EMBODIMENT

The present invention will be described below throughout an embodiment of the invention. However, the embodiment below does not limit the invention according to the scope of claims, and not all combinations of features described in the embodiment are essential to the solving means of the invention.

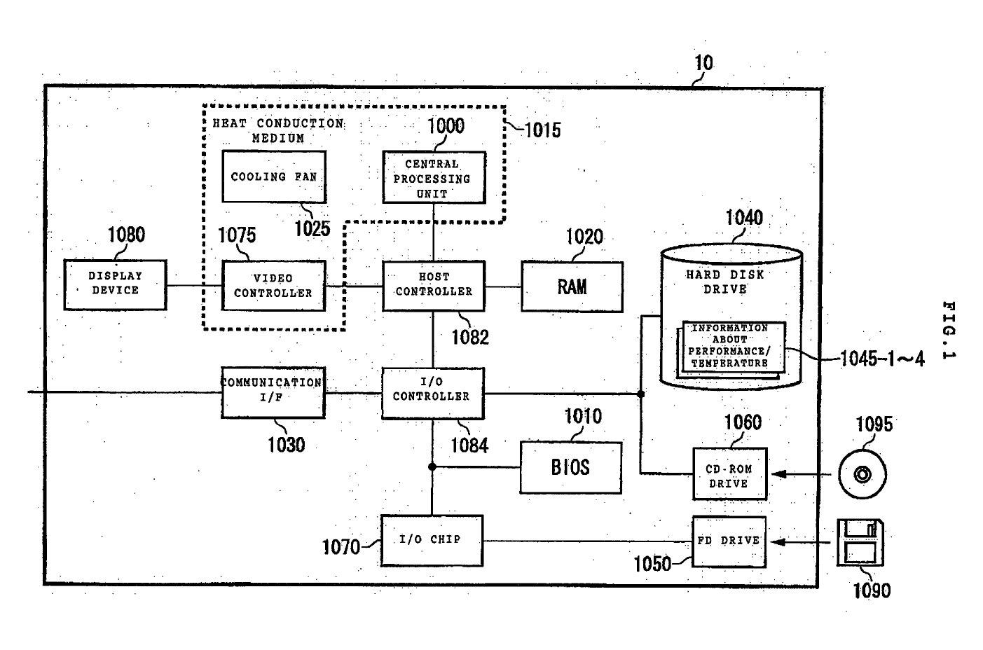

FIG. 1 shows a configuration of an information processing apparatus 10. The information processing apparatus 10 includes a central processing unit peripheral section having the central processing unit (CPU) 1000, a RAM 1020 and a video controller 1075, which are interconnected by a host controller 1082. Moreover, the information processing apparatus 10 includes an input/output section having a communication interface 1030, a hard disk drive 1040, and a CD-ROM drive 1060, which are connected to the host controller 1082 by an input/output controller 1084. Furthermore, the information processing apparatus 10 includes a legacy input/output section having a BIOS 1010 and an input/output chip 1070, which are connected to the input/output controller 1084.

Each of the central processing unit 1000 and the video controller 1075 is an example of a device according to the present invention, and has a high-power mode in which power consumption and/or processing speed are high, and a low-power mode in which the power consumption and/or the processing speed are lower than those of the high-power mode. More specifically, the high-power mode is a mode in which operation frequency and/or driving voltage is high, and the low-power mode is a mode in which the operation frequency and/or the driving voltage is lower than that of the high-power mode.

Moreover, heat generated in the central processing unit 1000 and the video controller 1075 is exhausted through a heat conduction medium 1015, which is a common heat conduction medium thereto. As an example, the thermal interface 1015 is a highly thermal conductive metal structure called a heat sink or a heat pipe. Moreover, the central processing unit 1000 and the video controller 1075 are situated in a state where a thermal correlation therebetween is intense due to their positions close to each other and the like, and the heat therein may be exhausted by gas or liquid (for example, air or water) as a common heat conduction medium thereto. Furthermore, the information processing apparatus 10 may include a cooling fan 1025 which indirectly cools the respective devices by cooling the heat conduction medium 1015, or directly cools the respective devices.

The host controller 1082 connects the RAM 1020 to the central processing unit 1000 and the video controller 1075 which access the RAM 1020 at a high transfer rate. The central processing unit 1000 operates based on programs stored in the BIOS 1010 and the RAM 1020, and controls the respective sections. The video controller 1075 acquires image data which the central processing unit 1000 and the like create on a frame buffer provided in the RAM 1020, and displays an image based on the acquired image data on a display device 1080. Alternatively, the video controller 1075 may include therein the frame buffer which stores the image data created by the central processing unit 1000 and the like.

The input/output controller 1084 connects the host controller 1082 to the communication interface 1030, the hard disk drive 1040, and the CD-ROM drive 1060, which are relatively high-speed input/output devices. The communication interface 1030 communicates with an external apparatus through a network.

The hard disk drive 1040 is one of the examples of a performance index value storage unit and a device information storage unit according to the present invention, and stores information about performance/temperature 1045-1 to 1045-4. Here, the information about performance/temperature is information indicating, in association with each of plural sets of operation modes set for plural devices, index values of processing performances and temperatures and amounts of power consumption of each of the devices in the case that the set concerned of operation modes is set. Moreover, the information about performance/temperature 1045-1 to 1045-4 is, for each of plural pieces of processing mutually different in type, performance/temperature information in the case that the processing of the type concerned is executed. The CD-ROM drive 1060 reads a program or data from a CD-ROM 1095, and provides the read program or data to the central processing unit 1000 and the like through the RAM 1020.

Moreover, the BIOS 1010 and a relatively low-speed input/output device such as the input/output chip 1070 are connected to the input/output controller 1084. The BIOS 1010 stores a boot program executed by the central processing unit 1000 at the time of activating the information processing apparatus 10, a program depending on hardware of the information processing apparatus 10, and the like. A flexible disk drive 1050 is connected to the input/output chip 1070. The flexible disk drive 1050 reads a program or data from a flexible disk 1090, and provides the read program or data to the central processing unit 1000 and the like through the RAM 1020. To the information processing apparatus 10, the input/output chip 1070 connects the flexible disk 1090, and various input/output devices through, for example, a parallel port, a serial port, a keyboard port, a mouse port and the like.

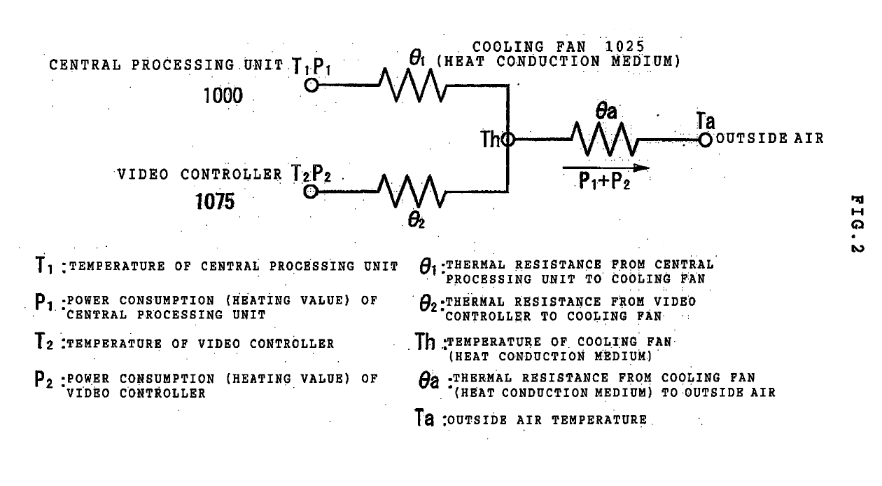

The programs provided to the information processing apparatus 10 are stored in a recording medium such as the flexible disk 1090, the CD-ROM 1095 and an IC card, and are inputted by a user. The programs are read from the recording medium through the input/output chip 1070 and/or the input/output controller 1084, and installed and executed in the information processing apparatus 10. Operations which the programs cause the information processing apparatus 10 to perform are not explained in detail here and will be described below since they are the same as operations in the information processing apparatus 10, which will be described with reference to FIGS. 2 to 9.

The programs described above may be stored in an external storage medium. As the storage medium, besides the flexible disk 1090 and the CD-ROM 1095, usable are an optical recording medium such as a DVD and a PD, a magneto-optical recording medium such as an MD, a tape medium, a semiconductor memory such as an IC card, and the like. Moreover, by using, as the recording medium, a storage device such as a hard disk, a RAM and the like which is provided in a server system connected to a private communication network or the Internet, the programs may be provided to the information processing apparatus 10 through the network concerned.

FIG. 2 shows an example of heat conduction in the information processing apparatus 10. The heat conduction between the central processing unit 1000, the video controller 1075, the cooling fan 1025 and the outside air will be described by using FIG. 2. Temperature of the central processing unit 1000 is defined as T₁, and power consumption thereof is defined as P₁. Temperature of the video controller 1075 is defined as T₂, and power consumption thereof is defined as P₂. Thermal resistance from the central processing unit 1000 to the cooling fan 1025 is defined as θ₁, and thermal resistance from the video controller 1075 to the cooling fan 1025 is defined as θ₂. Moreover, temperature in the cooling fan 1025 is defined as Th. Thermal resistance from the cooling fan 1025 to the outside air is defined as θₐ. Furthermore, temperature of the outside air of the information processing apparatus 10 is defined as Tₐ.

A relationship between the temperature of the central processing unit 1000 and the temperature in the cooling fan 1025 is determined by the following Formula (1) by using a heating value generated in the central processing unit 1000 and the thermal resistance between the central processing unit 1000 and the cooling fan 1025.
T₁=P₁θ₁+Th Formula (1)

Moreover, a relationship between the temperature of the video controller 1075 and the temperature in the cooling fan 1025 is determined by the following Formula (2) by using a heating value generated in the video controller 1075 and the thermal resistance between the video controller 1075 and the cooling fan 1025.
T₂=P₂θ₂+Th Formula (2)

Furthermore, a relationship between the temperature in the cooling fan 1025 and the temperature of the outside air is determined by the following Formula (3) by using the thermal resistance between the cooling fan 1025 and the outside air, and the heating values generated in the central processing unit 1000 and the video controller 1075.
Th=(P₁+P₂)θₐ+Tₐ Formula (3)

The following Formulas (4) and (5) are derived from Formulas (1) to (3).
T₁=P₁(θ₁+θₐ)+P₂θₐ+Tₐ Formula (4)
T₂=P₁θₐ+P₂(θ₂+θₐ)+Tₐ Formula (5)

Here, a first item on a right-hand side of Formula (4) represents the heat generated in the central processing unit 1000 itself. Meanwhile, a second item on the right-hand side of Formula (4) represents indirectly induced heating-up which follows the heat generation of the video controller 1075. In a similar way, a second item on a right-hand side of Formula (5) represents the heat generated in the video controller 1075 itself. Meanwhile, a first item on the right-hand side of Formula (5) represents indirectly induced heating-up which follows the heat generated in the central processing unit 1000.

As described above, when the heat generated in the plural devices is exhausted by the common heat conduction medium, each of the devices sometimes receives the radiation heat from the other device. Therefore, even if the temperature of only one device exceeds the reference temperature, measures against the heat generated by the devices including the other devices are required.

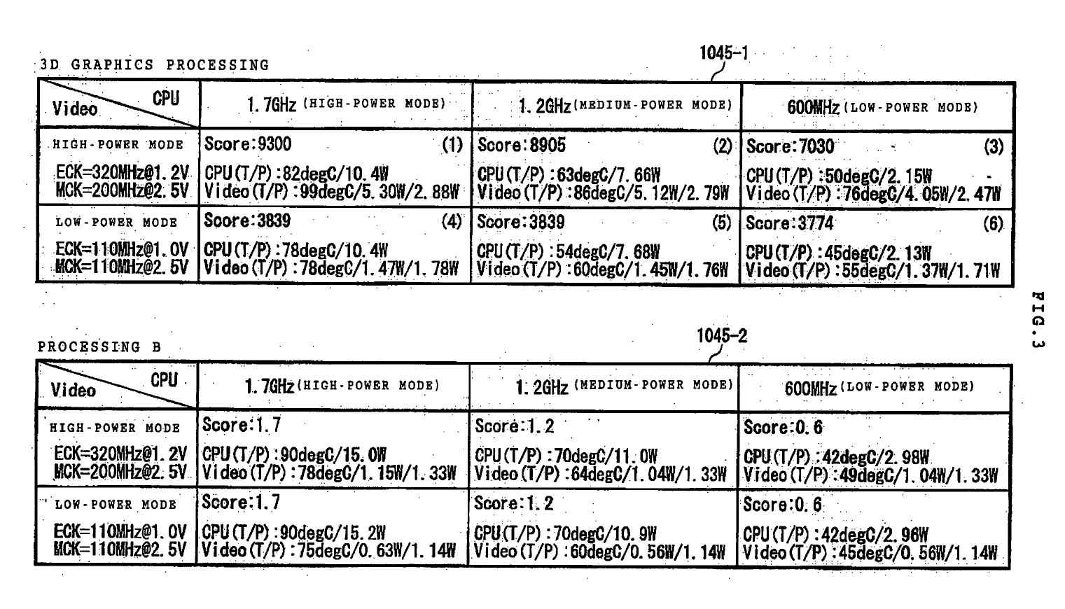

FIG. 3 illustrates information about the performance/temperature 1045-1 and information about the performance/temperature 1045-2 with examples. The information about performance/temperature 1045-1 indicates index values of performance indices when the information processing apparatus 10 executes 3D graphics processing. The index values in this case are ready for each of the respective sets of operation modes set for the plural devices. Moreover, the information about performance/temperature 1045-1 indicates temperatures and amounts of power consumption of the respective devices when the information processing apparatus 10 executes the 3D graphics processing. The temperatures and the amounts of power consumption in this case are ready for each of the respective operation modes set for the plural devices.

Specifically, the information about the performance/temperature 1045-1 indicates index values, temperatures and power consumptions in the case that the central processing unit 1000 operates in any one of a high-power mode, a medium-power mode and a low-power mode and the video controller 1075 operates in any one of a high-power mode and a low-power mode. Here, the plural operation modes of the central processing unit 1000 are mutually different in, for example, operation frequency and driving voltage. As an example, the operation frequency in the high-power mode is 1.7 GHz, the operation frequency in the medium-power mode is 1.2 GHz, and the operation frequency in the low-power mode is 600 MHz.

Moreover, the plural operation modes of the video controller 1075 are mutually different in, for example, operation frequency and driving voltage. As an example, while an engine clock (ECK) is 320 MHz and the driving voltage is 1.2V in the high-power mode, the ECK is 110 MHz and the driving voltage is 1.0V in the low-power mode. Furthermore, while a memory clock (MCK) is 200 MHz in the high-power mode, the MCK is 110 MHz in the low-power mode.

Here, the index values of the processing performance are, for example, scores in the case of executing a predetermined benchmark test which executes processing of a corresponding type. Moreover, the stored temperatures are, for example, temperatures of the respective devices, which are actually measured in the case of executing the benchmark test concerned. Furthermore, the stored amounts of power consumption are, for example, amounts of power consumption of the respective devices, which are actually measured in the case of executing the benchmark test concerned.

More specifically, when the central processing unit 1000 operates in the high-power mode and the video controller 1075 operates in the high-power mode, the index value is 9300, and the temperatures of the central processing unit 1000 and the video controller 1075 are 82° C. and 99° C., respectively. Moreover, when the central processing unit 1000 operates in the medium-power mode and the video controller 1075 operates in the high-power mode, the index value is 8905, and the temperatures of the central processing unit 1000 and the video controller 1075 are 63° C. and 86° C., respectively.

Moreover, when the central processing unit 1000 operates in the low-power mode and the video controller 1075 operates in the high-power mode, the index value is 7030, and the temperatures of the central processing unit 1000 and the video controller 1075 are 50° C. and 76° C., respectively. When the central processing unit 1000 operates in the high-power mode and the video controller 1075 operates in the low-power mode, the index value is 3839, and the temperatures of the central processing unit 1000 and the video controller 1075 are 78° C. individually.

Furthermore, when the central processing unit 1000 operates in the medium-power mode and the video controller 1075 operates in the low-power mode, the index value is 3839, and the temperatures of the central processing unit 1000 and the video controller 1075 are 54° C. and 60° C., respectively. Moreover, when the central processing unit 1000 operates in the low-power mode and the video controller 1075 operates in the low-power mode, the index value is 3774, and the temperatures of the central processing unit 1000 and the video controller 1075 are 45° C. and 55° C., respectively.

In place of the example of FIG. 3, the information about performance/temperature 1045-1 may include only data of the temperatures of the respective devices in association with each of the respective sets of operation modes, and may not have to include data of the amounts of power consumption. Alternatively, the information about performance/temperature 1045-1 may include only the data of the amounts of power consumption of the respective devices, and may not have to include the data of the temperatures. In this case, an operation mode selection unit 420 to be described later as a functional block in the central processing unit 1000 may calculate predicted values of the data of the temperatures based on the data of the amounts of power consumption, and may perform processing based on the calculated predicted values of the data of the temperatures.

The information about performance/temperature 1045-2 indicates index values of performance indices when the information processing apparatus 10 executes processing B different in type from the 3D graphics processing. The index values in this case are ready for each of the respective sets of operation modes set for the plural devices. Moreover, the information about performance/temperature 1045-2 indicates temperatures and power consumptions of the respective devices when the information processing apparatus 10 executes the processing B. The temperatures and the power consumptions in this case are ready for each of the respective sets of operation modes set for the plural devices. General outlines of each of the respective parameters are substantially the same as those of the information about performance/temperature 1045-1, and accordingly, description thereof will be omitted.

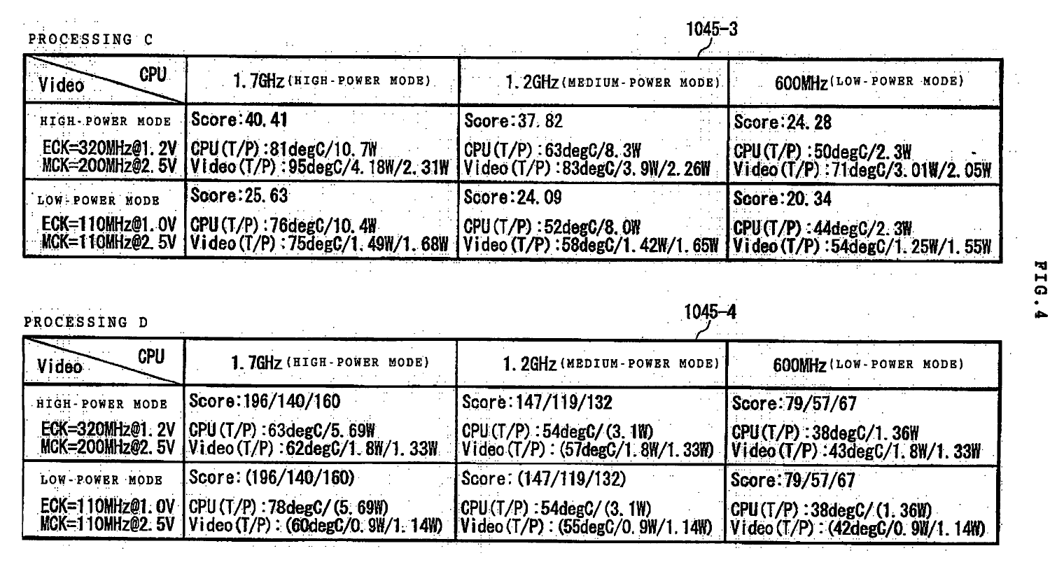

FIG. 4 shows examples of the information about performance/temperature 1045-3 and the information about performance/temperature 1045-4. The information about performance/temperature 1045-3 indicates index values of performance indices when the information processing apparatus 10 executes processing C different in type from the 3D graphics processing and the processing B. The index values in this case are ready for each of the respective sets of operation modes set for the plural devices. Moreover, the information about performance/temperature 1045-3 indicates temperatures and power consumptions of the respective devices when the information processing apparatus 10 executes the processing C. The temperatures and the power consumptions in this case are ready for each of the respective sets of operation modes set for the plural devices. General outlines of each of the respective parameters are substantially the same as those of the information about performance/temperature 1045-1, and accordingly, description thereof will be omitted.

The information about performance/temperature 1045-4 indicates index values of performance indices when the information processing apparatus 10 executes processing D different in type from the 3D graphics processing, the processing B and the processing C. The index values in this case are ready for each of the respective sets of operation modes set for the plural devices. Moreover, the information about performance/temperature 1045-4 indicates temperatures and power consumptions of the respective devices when the information processing apparatus 10 executes the processing D. The temperatures and the power consumptions in this case are ready for each of the respective sets of operation modes set for the plural devices. General outlines of each of the respective parameters are substantially the same as those of the information about performance/temperature 1045-1, and accordingly, description thereof will be omitted.

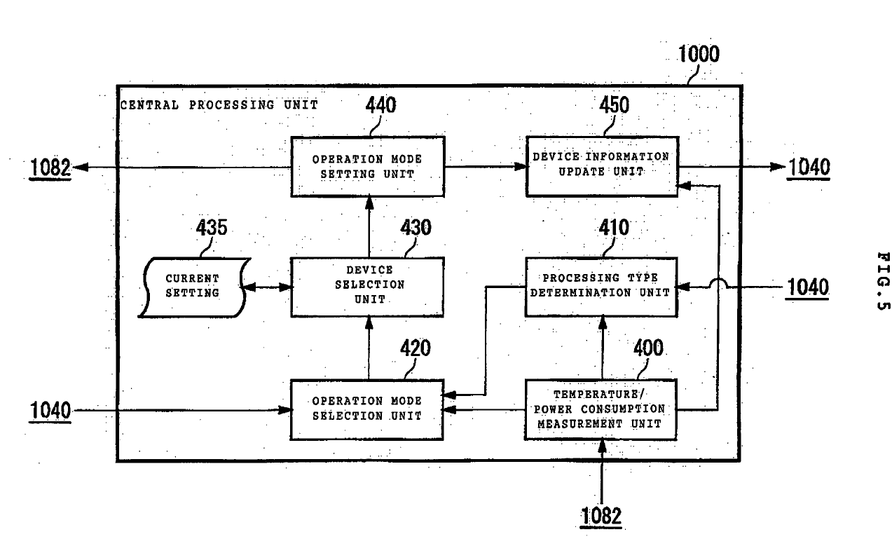

FIG. 5 shows an example of a functional block diagram of the central processing unit 1000. By the programs, the central processing unit 1000 functions as a temperature/power consumption measurement unit 400, a processing type determination unit 410, an operation mode selection unit 420, a device selection unit 430, an operation mode setting unit 440, and a device information update unit 450. The temperature/power consumption measurement unit 400 is an example of a measurement unit according to the present invention, and measures temperature of a predetermined measurement point in the information processing apparatus 10. As an example, the temperature/power consumption measurement unit 400 may measure the temperature of the video controller 1075 which is a predetermined device to be subjected to the temperature measurement by a temperature sensor provided in the video controller 1075, and may acquire a result of the measurement via the host controller 1082. Moreover, the temperature/power consumption measurement unit 400 measures the respective temperatures and amounts of power consumption of each of the plural devices provided in the information processing apparatus 10. In place of this, the temperature/power consumption measurement unit 400 may measure only the amounts of power consumption of the respective devices, and may calculate predicted values of the temperatures of the respective devices based on the measured power consumptions.

The processing type determination unit 410 determines the type of processing executed by the information processing apparatus 10 based on a distribution of the measured temperatures or amounts of power consumptions of the plural devices and a distribution of the temperatures or the amounts of power consumptions, which are stored in the hard disk drive 1040. For the type of processing, which is determined by the processing type determination unit 410, the operation mode selection unit 420 sequentially selects the sets of operation modes in order from a set of operation modes in which processing performance for executing the processing of the type is higher until the measured temperature of the measurement point falls to lower than the reference temperature.

The device selection unit 430 selects a device of which operation mode is to be changed from the high-power mode to the low-power mode based on the set of operation modes selected by the operation mode selection unit 420 and a current setting 435 indicating operation modes set for the respective devices at present. The operation mode setting unit 440 changes the operation mode of the selected device from the high-power mode to the low-power mode. Based on an amount of power consumption measured when the set of operation modes is set by the operation mode setting unit 440, the device information update unit 450 updates the amount of power consumption which the hard disk drive 1040 stores in association with the set concerned of operation modes. Moreover, based on temperature measured when the set of operation modes is set by the operation mode setting unit 440, the device information update unit 450 may update the data of the temperature which the hard disk drive 1040 stores in association with the set concerned of operation modes.

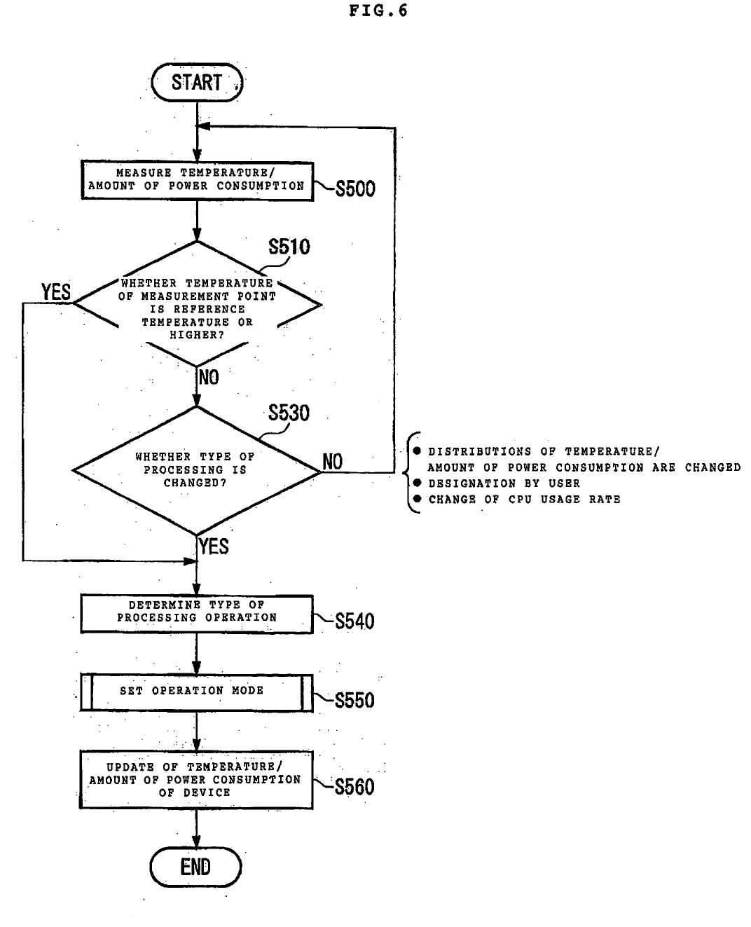

FIG. 6 shows an example of processing for changing the operation mode of the device from the high-power mode to the low-power mode. The temperature/power consumption measurement unit 400 measures the temperature of the predetermined measurement point in the information processing apparatus 10 (S500). For example, the temperature/power consumption measurement unit 400 measures the respective temperatures of each of the plural devices provided in the information processing apparatus 10. Then, when the temperature of any of the measurement points is equal to or higher than a reference temperature predetermined corresponding to the measurement point concerned (S510: YES), the information processing apparatus 10 shifts the processing to S540 and after, and changes the operation mode.

As a more detailed example, the information processing apparatus 10 may allow a user to designate a reference level of noise generated by rotation of the cooling fan 1025. In this case, the information processing apparatus 10 may shift the processing to S540 and after when the measurement point concerned cannot be cooled to lower than the reference temperature by the cooling fan 1025 with the rotation speed allowing noises to have a value less than the reference level. In place of this, the temperature/power consumption measurement unit 400 may measure temperature of a casing of the information processing apparatus 10, and the information processing apparatus 10 may shift the processing to S540 and after when the measured temperature of the casing is equal to or higher than a reference temperature of the casing.

Meanwhile, when the temperatures of all the measurement points are lower than the reference temperatures predetermined corresponding to the measurement points concerned (S510: NO), the processing type determination unit 410 determines whether or not the type of processing executed by the information processing apparatus 10 has been changed (S530). For example, the processing type determination unit 410 may determine that the type of processing has been changed when the distributions of the amounts of power consumptions of the plural devices have been changed equally or more than predetermined reference amounts. Specifically, the processing type determination unit 410 may determine whether or not the type of processing has been changed based on an absolute value of a difference between the amounts of power consumption of the respective devices, which were measured last time, and the amounts of power consumption of the respective devices, which were measured at this time. Moreover, the processing type determination unit 410 may determine that the type of processing has been changed when the distributions of the temperatures of the plural devices have been changed equally or more than predetermined reference amounts.

As another example, the processing type determination unit 410 may determine that the type of processing is changed in the case of receiving, from the user, an instruction to change the type of processing to be executed. Moreover, when a CPU usage rate of a certain application program exceeds a predetermined reference usage rate, the processing type determination unit 410 may determine that the type of processing to be executed by the information processing apparatus 10 has been changed to a type of processing to be executed by the application program concerned.

When the type of processing executed by the information processing apparatus 10 has been changed (S530: YES), the processing type determination unit 410 determines the type of processing executed by the information processing apparatus 10 (S540). For example, the processing type determination unit 410 may select processing of a type in which a distribution of the amount of power consumption is the most approximate to the distribution of the amount of power consumption of the measured device based on the information about performance/temperature 1045-1 to 1045-4, and may determine that the type of selected processing is the type of processing executed by the information processing apparatus 10.

In place of this, the processing type determination unit 410 may determine that the information processing apparatus 10 is executing processing of a type designated by the user. Moreover, for each application program, a type of processing executed by the application program concerned may be recorded in advance in association therewith, and the processing type determination unit 410 may determine that the processing of the type corresponding to the application program concerned is executed when the CPU usage rate of the certain application program exceeds the predetermined reference usage rate.

Next, the operation mode selection unit 420, the device selection unit 430 and the operation mode setting unit 440 set the operation modes (S550). Then, based on the temperature or the amount of power consumption, which is measured when the set of operation modes is set by the operation mode setting unit 440, the device information update unit 450 updates the data of the temperature or the amount of power consumption, which the hard disk drive 1040 stores in association with the set concerned of operation modes (S560). In place of or in addition to this, the device information update unit 450 may measure temperature of the outside air in the case that the information processing apparatus 10 performs processing for calculation of a predetermined reference amount or less, and based on the temperature of the outside air, may update the data of the temperature, which is stored by the information about performance/temperature 1045. In this case, preferably, the device information update unit 450 updates the data of the temperature and the amount of power consumption, which is stored by the information about performance/temperature 1045, for each time when the information processing apparatus 10 shifts to a suspended mode and resumes. Thus, only in the case that there is a high possibility that an external environment where the information processing apparatus 10 is placed has been changed, the data of the temperature and the amount of power consumption can be updated.

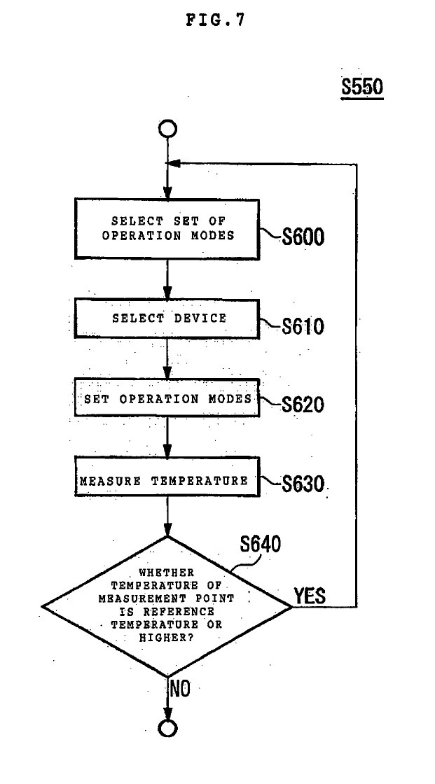

FIG. 7 shows details of the processing in S550 of FIG. 6. For the type of processing, which has been determined by the processing type determination unit 410, the operation mode selection unit 420 sequentially selects the sets of operation modes to be set in the device in order from the set of operation modes in which the processing performance for executing the processing of the type concerned is higher (S600). Based on the selected sets of operation modes, the current setting and the like, the device selection unit 430 selects the device in which the operation mode is changed from the high-power mode to the low-power mode (S610).

Then, the operation mode setting unit 440 changes the operation mode of the selected device from the high-power mode to the low-power mode (S620). After the changing, preferably, after a predetermined period elapses, the temperature/power consumption measurement unit 400 measures again the temperature of the device, which has been determined in S510 to be equal to or higher than the reference temperature (S630). When the temperature of the device does not fall to lower than the reference temperature (S640: YES), the operation mode selection unit 420 returns the processing to S600, and selects the set of operation modes again.

As described above, the operation mode selection unit 420 sequentially selects the sets of operation modes to be set for the device in order from the set of operation modes in which the processing performance is higher until the temperature of the measurement point falls to lower than the reference temperature. As a result, the device selection unit 430 can select a device capable of minimizing the lowering of the processing speed thereof in the case that the operation mode is changed from the high-power mode to the low-power mode to lower the temperature of the measurement point, and can change the operation mode of the device concerned. Meanwhile, when the temperature of the measurement point does not fall to lower than the reference temperature though the operation mode setting unit 440 has changed the operation mode from the high-power mode to the low-power mode, the device selection unit 430 can sequentially select the other devices to be second-best minimized the degradation in the processing performance, and can change the operation modes thereof.

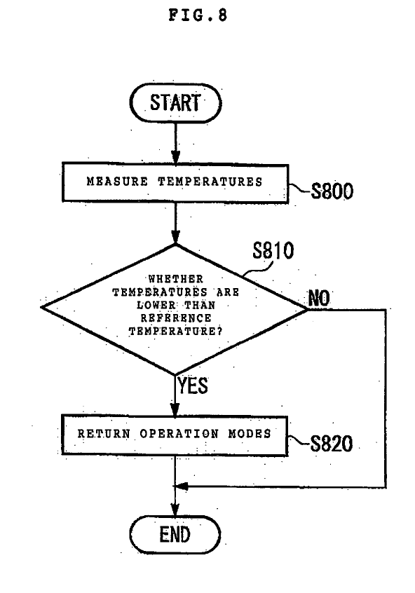

FIG. 8 shows an example of the processing for changing the operation mode of the device from the low-power mode to the high-power mode. The information processing apparatus 10 may perform the following processing, for example, periodically in the case that the operation mode has been changed from the high-power mode to the low-power mode by the processing of FIG. 7. The temperature/power consumption measurement unit 400 measures the respective temperatures of the plural devices provided in the information processing apparatus 10 (S800).

When the temperatures of all the devices are lower than the reference temperatures predetermined corresponding to the devices concerned (S810: YES), the operation mode selection unit 420 selects a set of operation modes corresponding to an index value indicating higher processing performance than that of the set of the operation modes set by the operation mode setting unit 440, and the operation mode setting unit 440 sets the selected set of operation modes (S820). As an example, the operation mode setting unit 440 may return the operation modes of the respective devices to operation modes set before changing the operation modes by the processing of FIG. 7. As a result, the device selection unit 430 can appropriately select the device in which the operation mode is changed from the low-power mode to the high-power mode.

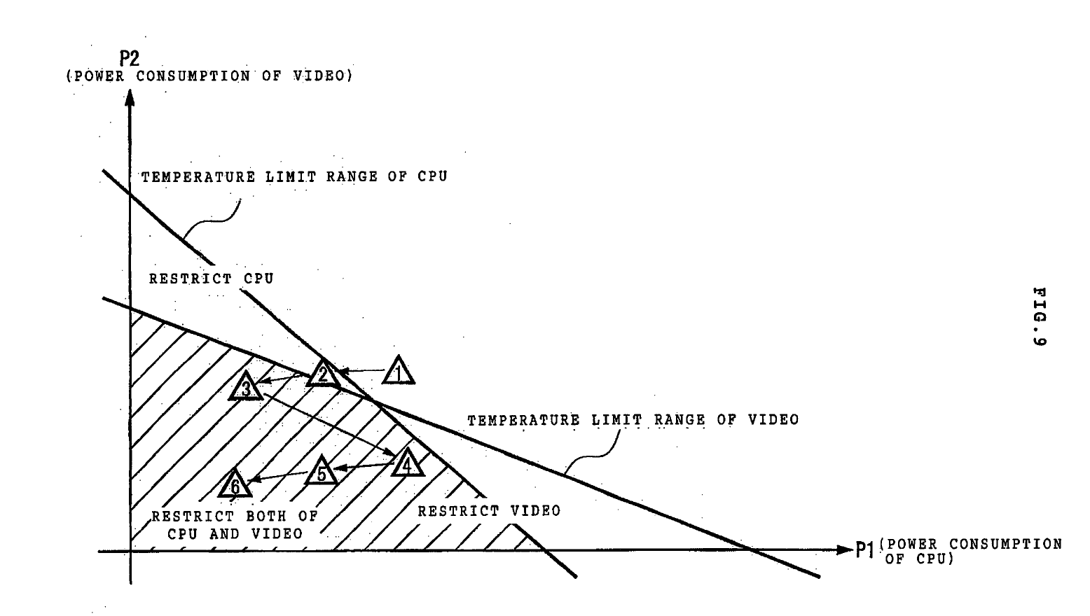

FIG. 9 shows temperature changes caused by changing the operation modes of the plural devices. An axis of abscissas of this graph represents the power consumption of the central processing unit 1000, and an axis of ordinates thereof represents the power consumption of the video controller 1075. One straight line in the graph defines a value range to be satisfied by the amounts of power consumption of the central processing unit 1000 and the video controller 1075 when the temperature of the central processing unit 1000 is set to be lower than the reference temperature. Specifically, ranges of P₁ and P₂ which set T₁ in the above-described Formula (4) to be less than a predetermined reference value are defined.

The other straight line defines a value range to be satisfied by the amounts of power consumption of the central processing unit 1000 and the video controller 1075 when the temperature of the video controller 1075 is set to be lower than the reference temperature. Specifically, ranges of P₁ and P₂ which set T₂ in the above-described Formula (5) to be less than a predetermined reference value are defined. Specifically, a shaded area represents a value range to be satisfied by the amounts of power consumption of the central processing unit 1000 and video controller 1075 in order to set the respective temperatures of the central processing unit 1000 and video controller 1075 to be lower than the reference temperatures.

Moreover, numbers 1 to 6 written into triangles in the graph correspond to (1) to (6) in the table of FIG. 3. Specifically, in the case of executing predetermined 3D graphics processing, when each of the central processing unit 1000 and the video controller 1075 is set in the high-power mode, the power consumptions of the central processing unit 1000 and the video controller 1075 become values shown in Triangle 1 in the graph. Then, when the operation mode of the central processing unit 1000 is sequentially changed to the medium-power mode and the low-power mode, the power consumptions of the central processing unit 1000 and the video controller 1075 are sequentially changed to values shown in Triangle 2 and Triangle 3 in the graph.

Furthermore, when the operation mode of the video controller 1075 is changed to the low-power mode, the power consumptions of the central processing unit 1000 and the video controller 1075 become values shown in Triangle 4 in the graph. Then, when the operation mode of the central processing unit 1000 is sequentially changed to the medium-power mode and the low-power mode, the power consumptions of the central processing unit 1000 and the video controller 1075 are sequentially changed to values shown in Triangle 5 and Triangle 6 in the graph.

Here, when each of the central processing unit 1000 and the video controller 1075 is operated in the high-power mode, both of the temperatures of the central processing unit 1000 and the video controller 1075 exceed the reference temperatures (Triangle 1). Then, when the central processing unit 1000 is changed to the medium-power mode (Triangle 2), the temperature of the central processing unit 1000 falls to lower than the reference temperature. In this case, in order to set the video controller 1075 at lower than the reference temperature, it is conceived to change the video controller 1075 to the low-power mode (Triangle 5) or to change the central processing unit 1000 to the low-power mode (Triangle 3).

In such a case, even if the video controller 1075 as an object for which the temperature is to be measured is at the reference temperature or higher, the device selection unit 430 selects the central processing unit 1000 as an object for which the operation mode is to be changed, under a condition that the degradation in the performance for the graphics processing can be more reduced in the case of changing the operation mode of the central processing unit 1000 than in the case of changing the operation mode of the video controller 1075. Thus, the degradation in the performance in the case of decreasing the heat generation can be restricted to the minimum in accordance with the type of processing under execution.

Although the present invention has been described above by using the embodiment, the technical scope of the present invention is not limited to the scope according to the above-described embodiment. It is obvious for those skilled in the art that a variety of alterations and improvements can be added to the above-described embodiment. It is obvious from the description of claims that aspects added with the alterations or improvements as described above can also be incorporated in the technical scope of the present invention.

According to the present invention, the degradation in the processing performance, which follows the control for decreasing a heating value, can be reduced.

Although the preferred embodiment of the present invention has been described in detail, it should be understood that various changes, substitutions and alternations can be made therein without departing from spirit and scope of the inventions as defined by appended claims.

What is claimed is:

1. Apparatus, comprising:
at least two devices, each having at least two operation modes corresponding to power consumption and/or processing speed thereof;
a measurement unit which measures temperature of a predetermined measurement point to be measured in the apparatus;
a device selection unit which selects a device to be minimized the degradation in processing performance in a case that the operation mode is changed from first operation mode to second operation mode in which the power consumption and/or the processing speed are lower than those in the first operation mode, to lower the temperature of the predetermined measurement point if the measured temperature is equal to or higher than a predetermined reference temperature; and
an operation mode setting unit which changes the operation mode of the selected device from the first operation mode to the second operation mode.

2. Apparatus according to claim 1,
wherein the at least two devices are associated with a common heat conduction to exhaust the heat generated thereby,
the measurement unit measures temperature of first device among the at least two devices, and
the device selection unit selects second device among the at least two devices under a condition that the degradation in the processing performance can be more reduced in a case of changing an operation mode of the second device than in the case of changing the operation mode of the first device if the temperature of the first device if the temperature of the first device is equal to or higher than the reference temperature determined corresponding to the first device.

3. Apparatus according to claim 1, further comprising:
a central processing unit; and
a video controller which controls image display,
wherein the measurement unit measures temperature of the video controller, and
the device selection unit selects the central processing unit under a condition that the degradation in the performance for graphics processing can be more reduced in a case of changing an operation mode of the central processing unit than in a case of changing an operation mode of the video controller when the temperature of the video controller is equal to or higher than the reference temperature determined corresponding to the video controller.

4. Apparatus according to claim 1, further comprising:
a performance index value storage unit which stores an index value of the processing performance of the case selected among the sets of operation modes for the devices, the index value of the processing performance is associated with each of the sets of the at least two operation modes for the at least two devices; and
an operation mode selection unit which selects the sets of operation modes sequentially in order from a set of operation modes in which the index value indicates higher processing performance until the temperature of the measurement point falls to lower than the reference temperature,
wherein the device selection unit selects the device, based on the selected set of operation modes, and changes the operation mode of the selected device from the first operation mode to the second operation mode.

5. Apparatus according to claim 4,
wherein the operation mode selection unit selects a set of operation modes corresponding to an index value indicating higher processing performance than the set of operation modes previously set by the operation mode setting unit if the temperature of the measurement point falls to lower than the reference temperature, and
the device selection unit selects the device, based on the selected set of operation modes and changes the operation mode of selected device from the second operation mode to the first operation mode.

6. Apparatus according to claim 4,
wherein, for each of plural types of processing operation, the performance index value storage unit stores an index value of the processing performance for executing the type of processing operation in association with each of the sets of the at least two operation modes for the at least two devices, and
for any designated type of processing operation, the operation mode selection unit selects the sets of operation modes sequentially in order from a set of operation modes in which the processing performance for executing the type of processing operation is the highest until the temperature of the measurement point falls to lower than the reference temperature.

7. Apparatus according to claim 6, further comprising:
a processing type determination unit which determines a type of processing executed by an application program,
wherein, for the type of processing determined by the processing type determination unit, the operation mode selection unit selects the sets of operation modes sequentially in order from a set of operation modes in which processing performance for executing the type of processing operation is higher until the temperature of the measurement point falls to lower than the reference temperature.

8. Apparatus according to claim 6,
wherein the measurement unit further measures any of temperature and/or an amount of the power consumption of each of the at least two devices,
the information processing apparatus further comprises a processing type determination unit which determines a type of processing executed based on any of a distribution of the temperatures and/or a distribution of the amounts of power consumption of the at least two devices, and
for the type of processing determined by the processing type determination unit, the operation mode selection unit selects the sets of operation modes sequentially in order from a set of operation modes in which processing performance for executing the type of processing operation is higher until the temperature of the measurement point falls to lower than the reference temperature.

9. Apparatus according to claim 8, further comprising:
a device information storage unit which stores, in association with each of the sets of at least two operation modes for the at least two devices, any of the temperature and/or the amount of power consumption of each of the at least two devices in the case that the set of operation modes is changed; and
a device information update unit which updates the temperature and/or the amount of power consumption stored in the device information storage unit in association with the set of operation modes to the temperature and/or the amount of power consumption of each of the at least two devices being measured in the case that the set of operation modes is changed by the operation mode setting unit,
wherein the processing type determination unit determines the type of processing executed based on any of the measured temperatures and/or amounts of power consumption of the at least two devices and any of the temperature and/or amount of power consumption of each of the devices, the temperature and/or the amount of power consumption being stored in the device information storage unit.

10. Apparatus according to claim 8,
wherein, in a case that any of the distribution of the temperatures and/or the distribution of the amounts of power consumption of the at least two devices is changed equally or more than a predetermined reference value,
the processing type determination unit determines the type of processing executed, and
for the type of processing determined by the processing type determination unit, the operation mode selection unit selects the sets of operation modes sequentially in order from a set of operation modes in which an index value in a case of executing the type of processing operation indicates higher processing performance until the temperature of the measurement point falls to lower than the reference temperature.

11. Apparatus according to claim 1, wherein the measurement unit measures temperature of a casing of the information processing apparatus which includes the at least two devices therein, and
the device selection unit selects the device in which the operation mode is changed from the first operation mode to the second operation mode if the measured temperature of the casing is equal to or higher than a reference temperature of the casing, and
the operation mode setting unit changes the operation mode of the selected device from the first operation mode to the second operation mode.

12. Apparatus according to claim 1, further comprising:
a cooling fan which cools the measurement point,
wherein the device selection unit selects the device in which the operation mode is changed from the first operation mode to the second operation mode when the temperature of the measurement point is equal to or higher than the reference temperature even if the cooling fan cools with the rotation speed allowing noises to have a value less than a predetermined reference level, and
the operation mode setting unit changes the operation mode of the selected device from the first operation mode to the second operation mode.

13. Apparatus according to claim 1,
wherein, in a case that the temperature of the measurement point does not fall to lower than the reference temperature when the operation mode setting unit changes the operation mode of the device from the first operation mode to the second operation mode, the device selection unit selects another device to be second-best minimized the degradation in the processing performance, and
the operation mode setting unit changes an operation mode of the other device selected by the device selection unit from the first operation mode to the second operation mode.

14. A method comprising:
measuring the temperature of a predetermined measurement point to be measured in an information processing apparatus which includes at least two devices, each device having at least two operation modes corresponding to the power consumption and the processing speed thereof;
selecting a device to be minimized the degradation in processing performance if an operation mode is changed from first operation mode to second operation mode in which the power consumption and/or the processing speed are lower than those in the first operation mode to lower the temperature of the measurement point in a case that the measured temperature is equal to or higher than a predetermined reference temperature; and
changing the operation mode of the selected device from the first operation mode to the second operation mode.

15. A product comprising:
a computer usable medium having computer readable program code stored therein for controlling heat generation of an information processing apparatus which includes at least two devices, each device having at least two operation modes corresponding to power consumption and/or processing speed thereof, the computer readable program code in said product being effective to:
measure temperature of a predetermined measurement point to be measured in the apparatus;
select a device to be minimized the degradation in processing performance if an operation mode is changed from the first operation mode to the second operation mode in which the power consumption and/or the processing speed are lower than those in the first operation mode to lower the temperature of the measurement point in a case that the measured temperature is equal to or higher than a predetermined reference temperature; and
change the operation mode of the selected device from the first operation mode to the second operation mode.
